(19) United States
(12) Patent Application Publication
(10) Pub. No.: US 2013/0162952 A1
(43) Pub. Date: Jun. 27, 2013

(54) Multiple Laser Projection System

(71) Applicant: LASER LIGHT ENGINES, INC., Salem, NH (US)

(72) Inventors: Barret Lippey, Belmont, MA (US); John Arntsen, Manchester-by-the-Sea, MA (US); Ian Lee, Chester, NH (US)

(73) Assignee: LASER LIGHT ENGINES, INC., Salem, NH (US)

(21) Appl. No.: 13/775,864

(22) Filed: Feb. 25, 2013

Related U.S. Application Data
(63) Continuation-in-part of application No. 12/962,185, filed on Dec. 7, 2010.

(51) Int. Cl. G02B 27/48; G03B 21/20

(52) U.S. Cl. CPC G02B 27/48; G03B 21/2033
USPC 353/7; 353/121; 353/31

(57) ABSTRACT

A method and apparatus for despeckling that includes a green laser diode, a DPSS laser, and stimulated Raman scattering light formed in an optical fiber. The laser diode light and stimulated Raman scattering light are combined to form a projected digital image. The output of the optical fiber may be split into two spectrums. The projected digital image may be stereoscopic with one image formed from the laser diode light and one spectrum, and the other image formed from the other spectrum.

### BACKGROUND OF THE INVENTION

There are many advantages for using laser light sources to illuminate digital projection systems, but the high coherence of laser light tends to produce undesirable speckle in the viewed image. Known despeckling methods generally fall into the categories of polarization diversity, angle diversion, and wavelength diversity. In the laser projection industry, there has been a long-felt need for more effective despeckling methods.

### SUMMARY OF THE INVENTION

In general, in one aspect, a method of image projection that includes generating green laser light from a laser diode, generating green laser light from a DPSS laser, focusing the DPSS light into an optical fiber, generating SRS light, using the SRS light to enhance an aspect of the light output from the optical fiber, and combining the laser diode light and the SRS light, to form a projected digital image.

Implementations may include one or more of the following features. The aspect of the light output of the optical fiber may be the color or the speckle level. The DPSS laser light may have a wavelength of 532 nm or 523.5 nm. There may also be a DPSS laser with a KGW Raman crystal, and the KGW Raman light may be combined with the green laser diode light and the SRS light to form a projected digital image. The KGW laser light may have a single light output at a wavelength of 545.4 nm. The light output of the optical fiber may be separated into two spectrums, and the first image of a stereoscopic image may be formed from the first green laser light and the first spectrum light, and the second image may be formed from the third green laser light and the second spectrum light.

In general, in one aspect, an optical apparatus that includes a green laser diode, a green DPSS laser, and an optical fiber. The DPSS laser light is focused into the optical fiber and the optical fiber generates SRS light that enhances an aspect of the light output of the optical fiber. The green laser diode light and the SRS light are combined to form a projected digital image.

Implementations may include one or more of the following features. The aspect of the light output of the optical fiber may be the color or the speckle level. The DPSS laser light may have a wavelength of 532 or 523.5 nm. There may be a KGW laser that generates green laser light. The KGW laser light, residual DPSS laser light, and SRS light may be combined to form a projected digital image. The KGW laser may have a single light output at a wavelength of approximately 545 nm. A beamsplitter may be employed to separate the light output of the optical fiber into two spectrums. The projected digital image may be a stereoscopic image. The first image of the stereoscopic image may be formed from the green laser diode light and one of the two spectrums, and the second image of the stereoscopic image may be formed from the KGW laser light and the second of the two spectrums.

### BRIEF DESCRIPTION OF THE SEVERAL VIEWS OF THE DRAWING

FIG. 1 is a graph of stimulated Raman scattering at moderate power;

FIG. 2 is a graph of stimulated Raman scattering at high power;

FIG. 3 is a top view of a laser projection system with a despeckling apparatus;

FIG. 4 is a color chart of a laser-projector color gamut compared to the Digital Cinema Initiative (DCI) and Rec. 709 standards;

FIG. 5 is a graph of color vs. power for a despeckling apparatus;

FIG. 6 is a graph of speckle contrast and luminous efficacy vs. color for a despeckling apparatus;

FIG. 7 is a top view of a laser projection system with an adjustable despeckling apparatus;

FIG. 8 is a graph of percent power into the first fiber, color out of the first fiber, and color out of the second fiber vs. total power for an adjustable despeckling apparatus;

FIG. 9 is a top view of a three-color laser projection system with an adjustable despeckling apparatus;

FIG. 10 is a block diagram of a three-color laser projection system with despeckling of light taken after an OPO;

FIG. 11 is a block diagram of a three-color laser projection system with despeckling of light taken before an OPO;

FIG. 12 is a block diagram of a three-color laser projection system with despeckling of light taken before and after an OPO;

FIG. 13 is a flowchart of a despeckling method;

FIG. 14 is a flowchart of an adjustable despeckling method;

FIG. 15 is a flowchart of a method of combining green light from a DPSS laser and green light from a laser diode.

FIG. 16 is a top view of a laser projector system that includes a green DPSS laser and a green laser diode.

FIG. 17 is a spectral graph of a laser projector system that includes a green DPSS laser and a green laser diode.

FIG. 18 is a color plot of a laser projector system that includes a green DPSS laser and a green laser diode.

FIG. 19 is a flowchart of a method of combining green light from a DPSS laser, green light from a laser diode, and green light from a KGW laser.

FIG. 20 is a top view of a laser projector system that includes a green DPSS laser, a green laser diode, and a KGW laser.

FIG. 21 is a spectral graph of a laser projector system that includes a green DPSS laser, a green laser diode, and a KGW laser.

FIG. 22 is a color plot of a laser projector system that includes a green DPSS laser, a green laser diode, and a KGW laser.

### DETAILED DESCRIPTION

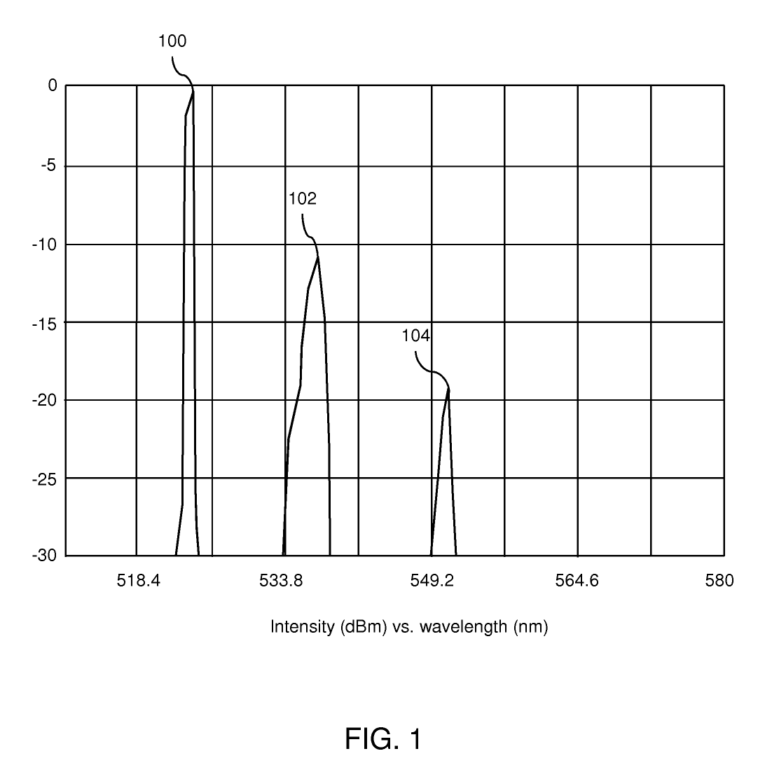

Raman gas cells using stimulated Raman scattering (SRS) have been used to despeckle light for the projection of images as described in U.S. Pat. No. 5,274,494. SRS is a non-linear optical effect where photons are scattered by molecules to become lower frequency photons. A thorough explanation of SRS is found in Nonlinear Fiber Optics by Govind Agrawal, Academic Press, Third Edition, pages 298-354. FIG. 1 shows a graph of stimulated Raman scattering output from an optical fiber at a moderate power which is only slightly above the threshold to produce SRS. The x-axis represents wavelength in nanometers (nm) and the y-axis represents intensity on a logarithmic scale in dBm normalized to the highest peak. First peak 100 at 523.5 nm is light which is not Raman scattered. The spectral bandwidth of first peak 100 is approximately 0.1 nm although the resolution of the spectral measurement is 1 nm, so the width of first peak 100 cannot be resolved in FIG. 1. Second peak 102 at 536.5 nm is a peak shifted by SRS. Note the lower intensity of second peak 102 as compared to first peak 100. Second peak 102 also has a much larger bandwidth than first peak 100. The full-width half-maximum (FWHM) bandwidth of second peak 102 is approximately 2 nm as measured at points which are −3 dBm down from the maximum value. This represents a spectral broadening of approximately 20 times compared to first peak 100. Third peak 104 at 550 nm is still lower intensity than second peak 102. Peaks beyond third peak 104 are not seen at this level of power.

Nonlinear phenomenon in optical fibers can include self-phase modulation, stimulated Brillouin Scattering (SBS), four wave mixing, and SRS. The prediction of which nonlinear effects occur in a specific fiber with a specific laser is complicated and not amenable to mathematical modeling, especially for multimode fibers. SBS is usually predicted to start at a much lower threshold than SRS and significant SBS reflection will prevent the formation of SRS. One possible mechanism that can allow SRS to dominate rather than other nonlinear effects, is that the mode structure of a pulsed laser may form a large number closely-spaced peaks where each peak does not have enough optical power to cause SBS.

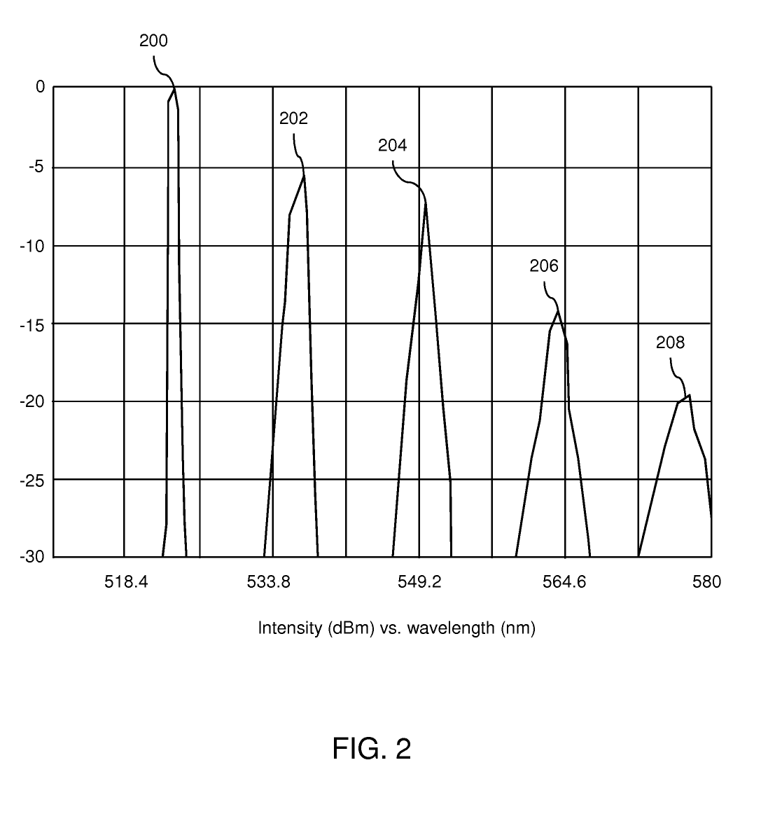

FIG. 2 shows a graph of stimulated Raman scattering at higher power than in FIG. 1. The x-axis represents wavelength in nanometers and the y-axis represents intensity on a logarithmic scale in dBm normalized to the highest peak. First peak 200 at 523.5 nm is light which is not Raman scattered. Second peak 202 at 536.5 nm is a peak shifted by SRS. Note the lower intensity of second peak 202 as compared to first peak 200. Third peak 204 at 550 nm is still lower intensity than second peak 202. Fourth peak 206 at 564 nm is lower than third peak 204, and fifth peak 208 at 578 nm is lower than fourth peak 206. At the higher power of FIG. 2, more power is shifted into the SRS peaks than in the moderate power of FIG. 1. In general, as more power is put into the first peak, more SRS peaks will appear and more power will be shifted into the SRS peaks. In the example of FIGS. 1 and 2, the spacing between the SRS peaks is approximately 13 to 14 nm. As can be seen in FIGS. 1 and 2, SRS produces light over continuous bands of wavelengths which are capable of despeckling by the mechanism of wavelength diversity. Strong despeckling can occur to the point where the output from an optical fiber with SRS shows no visible speckle under most viewing circumstances. Maximum and minimum points for speckle patterns are a function of wavelength, so averaging over more wavelengths reduces speckle. A detailed description of speckle reduction methods can be found in Speckle Phenomena in Optics, by Joseph W. Goodman, Roberts and Company Publishers, 2007, pages 141-186.

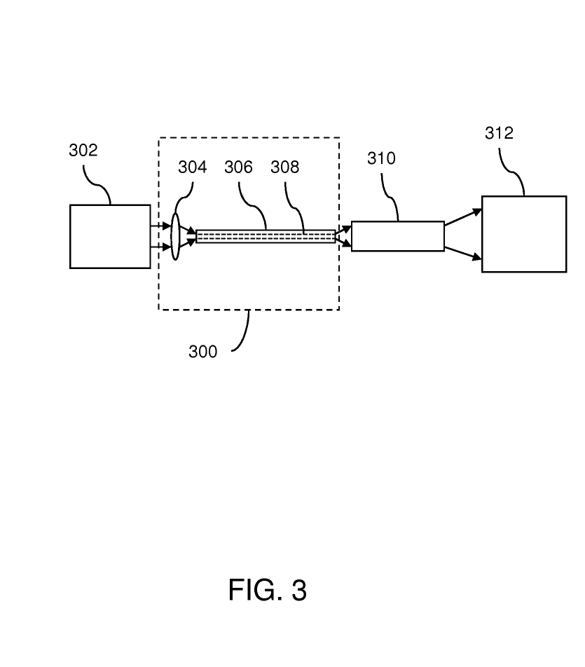

FIG. 3 shows a top view of a laser projection system with a despeckling apparatus based on SRS in an optical fiber. Laser light source 302 illuminates light coupling system 304. Light coupling system 304 illuminates optical fiber 306 which has core 308. Optical fiber 306 illuminates homogenizing device 310. Homogenizing device 310 illuminates digital projector 312. Illuminating means making, passing, or guiding light so that the part which is illuminated utilizes light from the part which illuminates. There may be additional elements not shown in FIG. 3 which are between the parts illuminating and the parts being illuminated. Light coupling system 304 and optical fiber 306 with core 308 form despeckling apparatus 300. Laser light source 302 may be a pulsed laser that has high enough peak power to produce SRS in optical fiber 306. Light coupling system 304 may be one lens, a sequence of lenses, or other optical components designed to focus light into core 308. Optical fiber 306 may be an optical fiber with a core size and length selected to produce the desired amount of SRS. Homogenizing device 310 may be a mixing rod, fly's eye lens, diffuser, or other optical component that improves the spatial uniformity of the light beam. Digital projector 312 may be a projector based on digital micromirror (DMD), liquid crystal device (LCD), liquid crystal on silicon (LCOS), or other digital light valves. Additional elements may be included to further guide or despeckle the light such as additional lenses, diffusers, vibrators, or optical fibers.

For standard fused-silica fiber with a numerical aperture of 0.22, the core size may be 40 micrometers diameter and the length may be 110 meters when the average input power is 3 watts at 523.5 nm. For higher or lower input powers, the length and/or core size may be adjusted appropriately. For example, at higher power, the core size may be increased or the length may be decreased to produce the same amount of SRS as in the 3 watt example. FIG. 1 shows the spectral output of a standard fused-silica fiber with a numerical aperture of 0.22, core size of 40 micrometers diameter and length of 110 meters when the average input power is 2 watts at 523.5 nm. FIG. 2 shows the output of the same system when the average input power is 4 watts. In both cases, the pulsed laser is a Q-switched, frequency-doubled neodymium-doped yttrium lithium fluoride (Nd:YLF) laser which is coupled into the optical fiber with a single aspheric lens that has a focal length of 18.4 mm. Alternatively, a frequency-doubled neodymium-doped yttrium aluminum garnet (Nd:YAG) laser may be used which has an optical output wavelength of 532 nm. The examples of average input powers in this specification are referenced to laser pulses with a pulse width of 50 ns and a frequency of 16.7 kHz.

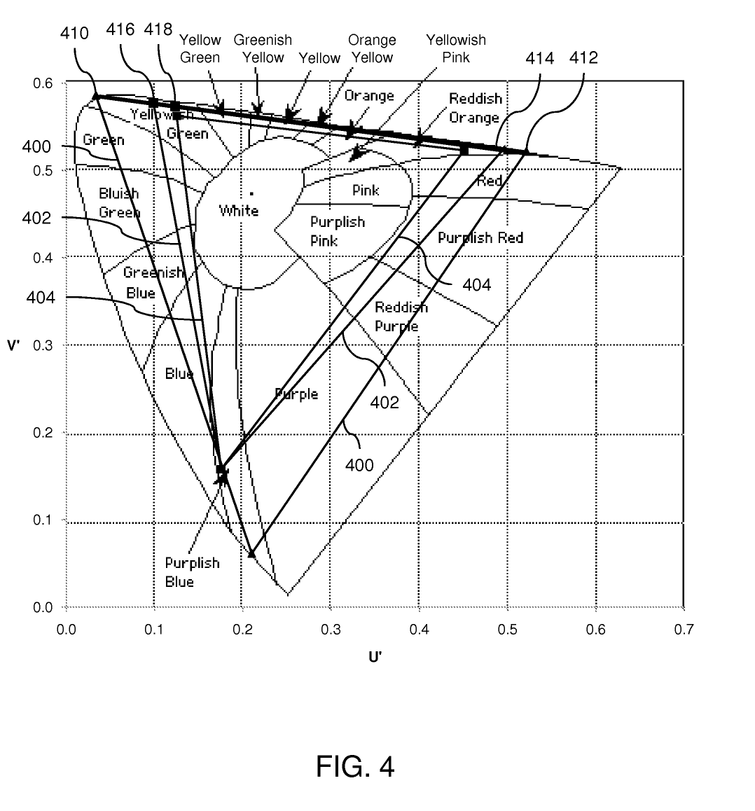

FIG. 4 shows a color chart of a laser-projector color gamut compared to the DCI and Rec. 709 standards. The x and y axes of FIG. 4 represent the u′ and v′ coordinates of the Commission Internationale de l'Eclairage (CIE) 1976 color space. Each color gamut is shown as a triangle formed by red, green, and blue primary colors that form the corners of the triangle. Other colors of a digital projector are made by mixing various amounts of the three primaries to form the colors inside the gamut triangle. First triangle 400 shows the color gamut of a laser projector with primary colors at 452 nm, 523.5 nm, and 621 nm. Second triangle 402 shows the color gamut of the DCI standard which is commonly accepted for digital cinema in large venues such as movie theaters. Third triangle 404 shows the color gamut of The International Telecommunication Union Radiocommunication (ITU-R) Recommendation 709 (Rec. 709) standard which is commonly accepted for broadcast of high-definition television. Green point 410 is the green primary of a laser projector at 523.5 nm. Red point 412 is the red primary of a laser projector at 621 nm. Line 414 (shown in bold) represents the possible range of colors along the continuum between green point 410 and red point 412. The colors along line 414 can be are obtained by mixing yellow, orange, and red colors with the primary green color. The more yellow, orange, or red color, the more the color of the green is pulled along line 414 towards the red direction. For the purposes of this specification, “GR color” is defined to be the position along line 414 in percent. For example, pure green at green point 410 has a GR (green-red) color of 0%. Pure red at red point 412 has a GR color of 100%. DCI green point 416 is at u′=0.099 and v′=0.578 and has a GR color of 13.4% which means that the distance between green point 410 and DCI green point 416 is 13.4% of the distance between green point 410 and red point 412. When the Rec. 709 green point of third triangle 404 is extrapolated to line 414, the resultant Rec. 709 green point 418 has a GR color of 18.1%. The concept of GR color is a way to reduce two-dimensional u′ v′ color as shown in the two-dimensional graph of FIG. 4 to one-dimensional color along line 414 so that other variables can be easily plotted in two dimensions as a function of GR color. In the case of a primary green at 523.5 nm experiencing SRS, the original green color is partially converted to yellow, orange, and red colors, which pull the resultant combination color along line 414 and increase the GR %. Although the DCI green point may be the desired target for the green primary, some variation in the color may be allowable. For example, a variation of approximately +/−0.01 in the u′ and v′ values may be acceptable.

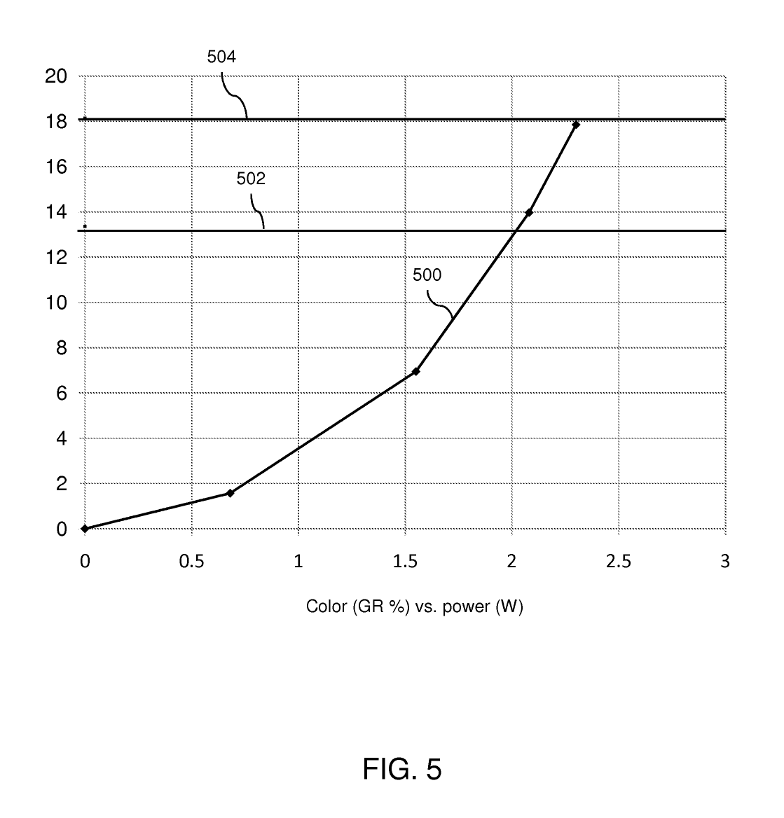

FIG. 5 shows a graph of color vs. power for a despeckling apparatus. The x-axis represents power in watts which is output from the optical fiber of a despeckling apparatus such as the one shown in FIG. 3. The y-axis represents the GR color in percent as explained in FIG. 4. The optical fiber has the same parameters as in the previous example (core diameter of 40 micrometers and length of 110 meters). Curve 500 shows how the color varies as a function of the output power. As the output power increases, the GR color gradually increases. The curve can be fit by the third-order polynomial

GR %=1.11p³+0.0787p²+1.71p+0.0041

where “p” is the output power in watts. First line 502 represents the DCI green point at a GR color of 13.4%, and second line 504 represents the Rec. 709 green point at approximately 18.1%. The average power output required to reach the DCI green point is approximately 2.1 W, and the average output power required to reach the Rec. 709 point is approximately 2.3 W.

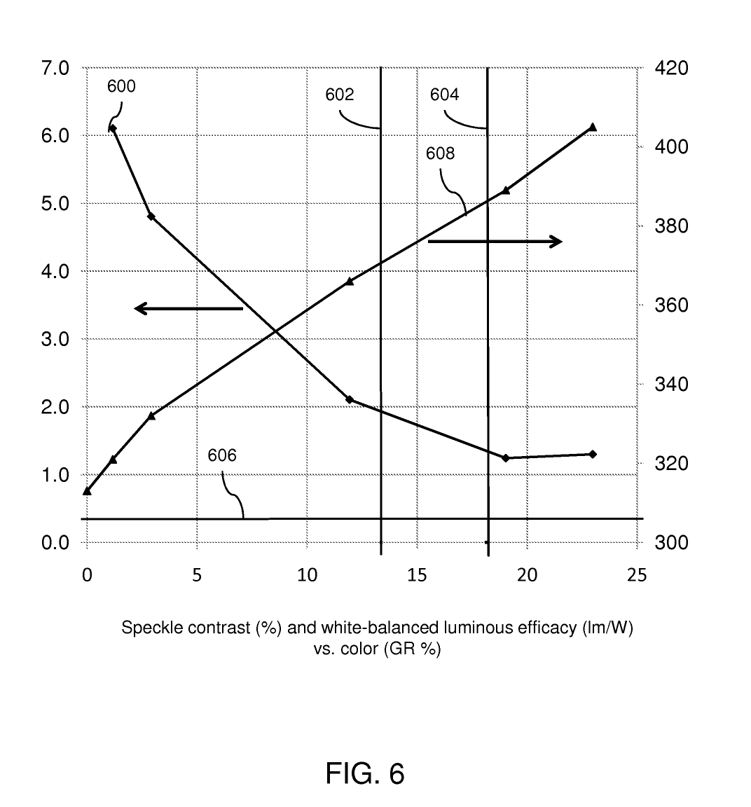

FIG. 6 shows a graph of speckle contrast and luminous efficacy vs. color for a despeckling apparatus such as the one shown in FIG. 3. The x-axis represents GR color in percent. The left y-axis represents speckle contrast in percent, and the right y-axis represents luminous efficacy in lumens per watt. Speckle contrast is a speckle characteristic that quantitatively represents the amount of speckle in an observed image. Speckle contrast is defined as the standard deviation of pixel intensities divided by the mean of pixel intensities for a specific image. Intensity variations due to other factors such as non-uniform illumination or dark lines between pixels (screen door effect) must be eliminated so that only speckle is producing the differences in pixel intensities. Measured speckle contrast is also dependent on the measurement geometry and equipment, so these should be standardized when comparing measurements. Other speckle characteristics may be mathematically defined in order to represent other features of speckle. In the example of FIG. 6, the measurement of speckle contrast was performed by analyzing the pixel intensities of images taken with a Canon EOS Digital Rebel XTi camera at distance of two screen heights. Automatic shutter speed was used and the iris was fixed at a 3 mm diameter by using a lens focal length of 30 mm and an f# of 9.0. Additional measurement parameters included an ISO of 100, monochrome data recording, and manual focus. The projector was a Digital Projection Titan that was illuminated with green laser light from a Q-switched, frequency-doubled, Nd:YLF laser which is coupled into a 40-micrometer core, 110 meter, optical fiber with a single aspheric lens that has a focal length of 18.4 mm. Improved uniformity and a small amount of despeckling was provided by a rotating diffuser at the input to the projector.

For the speckle-contrast measurement parameters described above, 1% speckle is almost invisible to the un-trained observer with normal visual acuity when viewing a 100% full-intensity test pattern. Conventional low-gain screens have sparkle or other non-uniformities that can be in the range of 0.1% to 1% when viewed with non-laser projectors. For the purposes of this specification, 1% speckle contrast is taken to be the point where no speckle is observable for most observers under most viewing conditions. 5% speckle contrast is usually quite noticeable to un-trained observes in still images, but is often not visible in moving images.

First curve 600 in FIG. 6 shows the relationship between measured speckle contrast and GR color. As the GR color is increased, the speckle contrast is decreased. Excellent despeckling can be obtained such that the speckle contrast is driven down to the region of no visible speckle near 1%. In the example of FIG. 6, first line 602 represents the DCI green point which has a speckle contrast of approximately 2% and second line 604 represents the Rec. 709 green point which has a speckle contrast of approximately 1%. The speckle contrast obtained in a specific configuration will be a function of many variables including the projector type, laser type, fiber type, diffuser type, and speckle-contrast measurement equipment. Third line 606 represents the minimum measurable speckle contrast for the system. The minimum measurable speckle contrast was determined by illuminating the screen with a broadband white light source and is equal to approximately 0.3% in this example. The minimum measurable speckle contrast is generally determined by factors such as screen non-uniformities (i.e. sparkle) and camera limitations (i.e. noise).

Second curve 608 in FIG. 6 shows the relationship between white-balanced luminous efficacy and GR color. The white-balanced luminous efficacy can be calculated from the spectral response of the human eye and includes the correct amounts of red light at 621 nm and blue light at 452 nm to reach the D63 white point. As the GR color is increased in the range covered by FIG. 6 (0% to 25%) the white-balanced luminous efficacy increases almost linearly from approximately 315 lm/w at a GR color of 0% to approximately 370 lm/w at the DCI green and approximately 385 lm/w at the Rec. 709 green point. This increase in luminous efficacy is beneficial to improve the visible brightness and helps compensate for losses that are incurred by adding the despeckling apparatus.

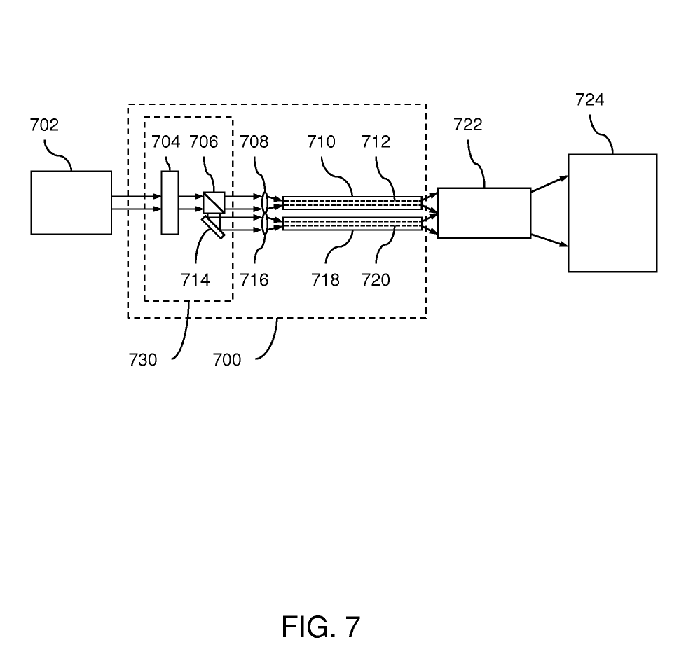

FIG. 7 shows a top view of a laser projection system with an adjustable despeckling apparatus. FIG. 7 incorporates two fibers for despeckling rather than the one fiber used for despeckling in FIG. 3. The despeckling apparatus of FIG. 3 allows tuning of the desired amount of despeckling and color point by varying the optical power coupled into optical fiber 306. FIG. 7 introduces a new independent variable which is the fraction of optical power coupled into one of the fibers. The balance of the power is coupled into the other fiber. The total power sent through the despeckling apparatus is the sum of the power in each fiber. The additional variable allows the despeckling and color point to be tuned to a single desired operation point for any optical power over a limited range of adjustment.

In FIG. 7, polarized laser light source 702 illuminates rotating waveplate 704. Rotating waveplate 704 changes the polarization vector of the light so that it contains a desired amount of light in each of two polarization states. Rotating waveplate 704 illuminates polarizing beamsplitter (PBS) 706. PBS 706 divides the light into two beams. One beam with one polarization state illuminates first light coupling system 708. The other beam with the orthogonal polarization state reflects off fold mirror 714 and illuminates second light coupling system 716. First light coupling system 708 illuminates first optical fiber 710 which has first core 712. First optical fiber 710 illuminates homogenizing device 722. Second light coupling system 716 illuminates second optical fiber 718 which has core 720. Second optical fiber 718 combines with first optical fiber 710 to illuminate homogenizing device 722. Homogenizing device 722 illuminates projector 724. Rotating waveplate 704, PBS 706, and fold minor 714 form variable light splitter 730. Variable light splitter 730, first light coupling system 708, second light coupling system 716, first optical fiber 710 with core 712, and second optical fiber 718 with core 720 form despeckling apparatus 700. Laser light source 702 may be a polarized, pulsed laser that has high enough peak power to produce SRS in first optical fiber 710 and second optical fiber 718. First light coupling system 708 and second light coupling system 716 each may be one lens, a sequence of lenses, or other optical components designed to focus light into first core 712 and second core 720 respectively. First optical fiber 710 and second optical fiber 718 each may be an optical fiber with a core size and length selected to produce the desired amount of SRS. First optical fiber 710 and second optical fiber 718 may be the same length or different lengths and may have the same core size or different core sizes. Additional elements may be included to further guide or despeckle the light such as additional lenses, diffusers, vibrators, or optical fibers.

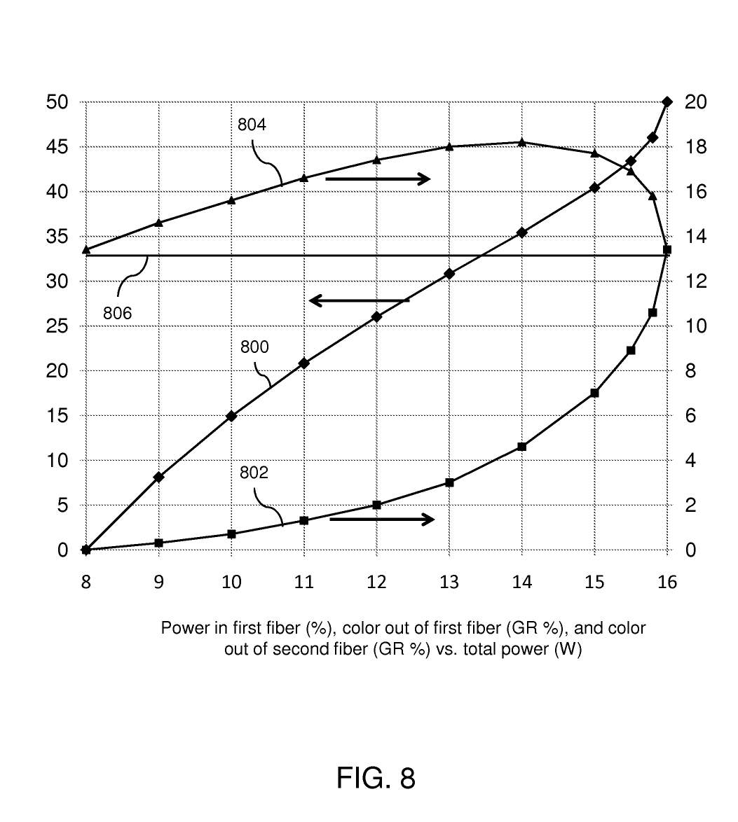

FIG. 8 shows a graph of power in the first optical fiber, color out of the first optical fiber, and color out of the second optical fiber vs. total power for an adjustable despeckling apparatus of the type shown in FIG. 7. The x-axis represents total average optical power in watts. The mathematical model used to derive FIG. 8 assumes no losses (such as scatter, absorption, or coupling) so the input power in each fiber is equal to the output power from each fiber. The total optical power equals the sum of the power in the first fiber and the second fiber. The left y-axis represents power in percent, and the right y-axis represents GR color in percent. In the example of FIG. 8, the target color is the DCI green point (GR color=13.4%). By adjusting the variable light splitter, all points in FIG. 8 maintain the DCI green point for the combined outputs of the two fibers. The two fibers are identical and each has a core diameter and length selected such that they reach the DCI green point at 8 watts of average optical power. The cubic polynomial fit described for FIG. 5 is used for the mathematical simulation of FIG. 8. First curve 800 represents the power in the first fiber necessary to keep the combined total output of both fibers at the DCI green color point. Line 806 in FIG. 8 represents the DCI green color point at a GR color of 13.4%. At 8 watts of total average power, 0% power into the first fiber and 100% power into the second fiber gives the DCI green point because the second fiber is selected to give the DCI green point. As the total power is increased, the variable light splitter is adjusted so that more power is carried by the first fiber. The non-linear relationship between power and color (as shown in curve 500 of FIG. 5) allows the combined output of both fibers to stay at the DCI green point while the total power is increased. At the maximum average power of 16 watts, the first fiber has 50% of the total power, the second fiber has 50% of the total power, and each fiber carries 8 watts.

Second curve 802 in FIG. 8 represents the color of the output of the first fiber. Third curve 804 in FIG. 8 represents the color of the output of the second fiber. Third curve 804 reaches a maximum at approximately 14 watts of total average power which is approximately 9 watts of average power in the second fiber. Because 9 watts is larger than the 8 watts necessary to reach DCI green in the second fiber, the GR color of light out of the second fiber is approximately 18% which is higher than the 13.4% for DCI green. As the total average power is increased to higher than 14 watts, the amount of light in the second fiber is decreased. When 16 watts of total average power is reached, each fiber reaches 8 watts of average power. The example of FIG. 8 shows that by adjusting the amount of power in each fiber, the overall color may be held constant at DCI green even though the total average power varies from 8 to 16 watts. Although not shown in FIG. 8, the despeckling is also held approximately constant over the same power range.

The previous example uses two fibers of equal length, but the lengths may be unequal in order to accomplish specific goals such as lowest possible loss due to scattering along the fiber length, ease of construction, or maximum coupling into the fibers. In an extreme case, only one fiber may be used, so that the second path does not pass through a fiber. Instead of a variable light splitter based on polarization, other types of variable light splitters may be used. One example is a variable light splitter based on a wedged multilayer coating that moves to provide more or less reflection and transmission as the substrate position varies. Mirror coatings patterned on glass can accomplish the same effect by using a dense minor fill pattern on one side of the substrate and a sparse minor fill pattern on the other side of the substrate. The variable light splitter may be under software control and feedback may be used to determine the adjustment of the variable light splitter. The parameter used for feedback may be color, intensity, speckle contrast, or any other measurable characteristic of light. A filter to transmit only the Raman-shifted light, only one Raman peaks, or specifically selected Raman peaks may be used with a photo detector. By comparing to the total amount of green light or comparing to the un-shifted green peak, the amount of despeckling may be determined. Other adjustment methods may be used instead of or in addition to the two-fiber despeckler shown in FIG. 7. For example, variable optical attenuators may be incorporated into the fiber, the numerical aperture of launch into the fiber may be varied, or fiber bend radius may be varied.

The example of FIG. 8 is a mathematical approximation which does not include second order effects such as loss and the actual spectrum of SRS. Operational tests of an adjustable despeckler using two identical fibers according to the diagram in FIG. 7 show that the actual range of adjustability may be approximately 75% larger than the range shown in FIG. 8.

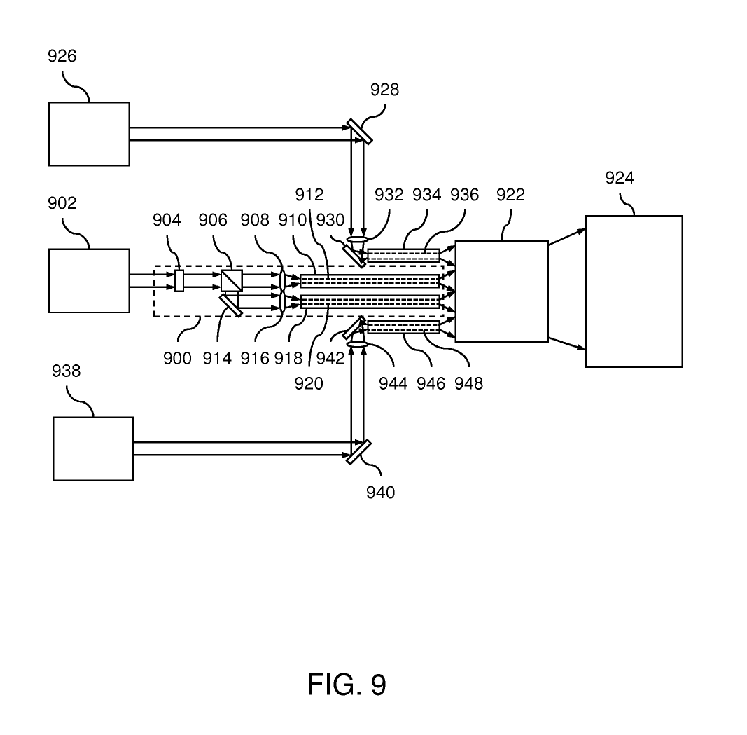

For a three-color laser projector, all three colors must have low speckle for the resultant full-color image to have low speckle. If the green light is formed from a doubled, pulsed laser and the red and blue light are formed by an optical parametric amplifier (OPO) from the green light, the red and blue light may have naturally low speckle because of the broadening of the red and blue light from the OPO. A despeckling apparatus such as the one described in FIG. 7 may be used to despeckle only the green light. A top view of such a system is shown in FIG. 9. First laser light source 926 illuminates first fold minor 928 which illuminates light coupling system 932. Light coupling system 932 illuminates second fold minor 930. Second fold mirror 930 illuminates optical fiber 934 which has core 936. Optical fiber 934 illuminates homogenizing device 922. Second laser light source 902 illuminates rotating waveplate 904. Rotating waveplate 904 changes the polarization vector of the light so that it contains a desired amount of light in each of two polarization states. Rotating waveplate 904 illuminates PBS 906. PBS 906 divides the light into two beams. One beam with one polarization state illuminates second light coupling system 908. The other beam with the orthogonal polarization state reflects off third fold minor 914 and illuminates third light coupling system 916. Second light coupling system 908 illuminates second optical fiber 910 which has second core 912. Second optical fiber 910 combines with first optical fiber 934 to illuminate homogenizing device 922. Third light coupling system 916 illuminates third optical fiber 918 which has core 920. Third optical fiber 918 combines with first optical fiber 934 and second optical fiber 910 to illuminate homogenizing device 922. Third laser light source 938 illuminates fourth fold minor 940 which illuminates fourth light coupling system 944. Fourth light coupling system 944 illuminates fifth fold mirror 942. Fifth fold mirror 942 illuminates optical fiber 946 which has core 948. Fourth optical fiber 946 combines with first optical fiber 934, second optical fiber 910, and third optical fiber 918 to illuminate homogenizing device 922. Homogenizing device 922 illuminates projector 924. Rotating waveplate 904, PBS 906, third fold minor 914, second light coupling system 908, third light coupling system 916, second optical fiber 910 with core 912, and third optical fiber 918 with core 920 form despeckling apparatus 900. First laser light source 926 may be a red laser, second laser light source 902 may be a green laser, and third laser light source 938 may be a blue laser. First laser light source 926 and third laser light source 938 may be formed by an OPO which operates on light from second laser light source 902. Second laser light source 902 may be a pulsed laser that has high enough peak power to produce SRS in second optical fiber 910 and third optical fiber 918. Additional elements may be included to further guide or despeckle the light such as additional lenses, diffusers, vibrators, or optical fibers.

FIG. 9 shows one color of light in each fiber. Alternatively, more than one color can be combined into a single fiber. For example, red light and blue light can both be carried by the same fiber, so that the total number of fibers is reduced from four to three. Another possibility is to combine red light and one green light in one fiber and combine blue light and the other green light in another fiber so that the total number of fibers is reduced to two.

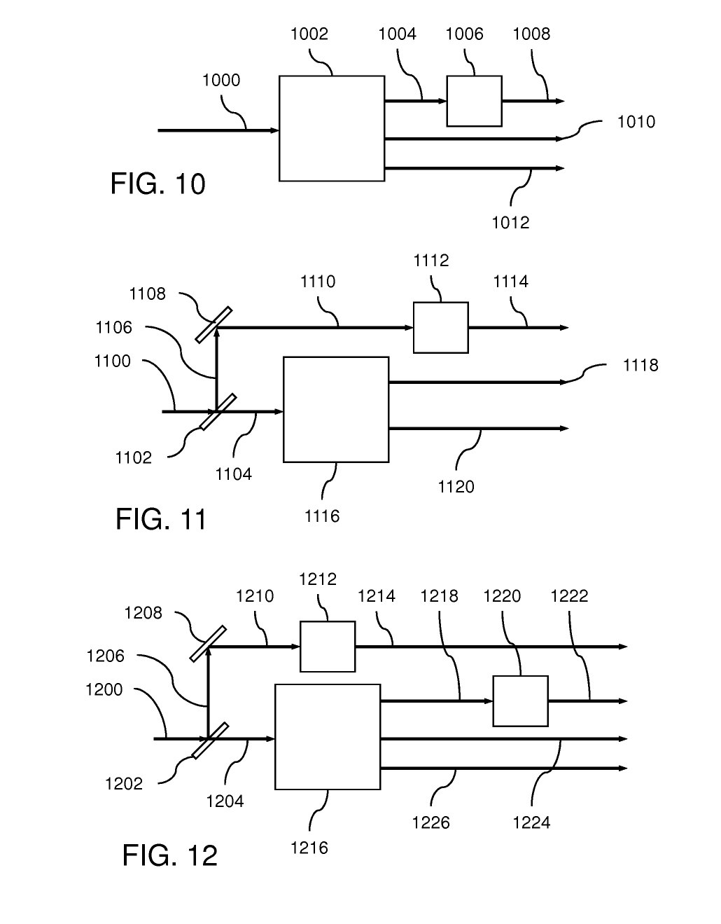

The despeckling apparatus may operate on light taken before, after, or both before and after an OPO. The optimum location of the despeckling apparatus in the system may depend on various factors such as the amount of optical power available at each stage and the amount of despeckling desired. FIG. 10 shows a block diagram of a three-color laser projection system with despeckling of light taken after an OPO. First beam 1000 enters OPO 1002. OPO 1002 generates second beam 1004, fourth beam 1010, and fifth beam 1012. Second beam 1004 enters despeckling apparatus 1006. Despeckling apparatus 1006 generates third beam 1008. First beam 1000, second beam 1004, and third beam 1008 may be green light. Fourth beam 1010 may be red light, and fifth beam 1012 may be blue light. Despeckling apparatus 1006 may be a fixed despeckler or an adjustable despeckler.

FIG. 11 shows a block diagram of a three-color laser projection system with despeckling of light taken before an OPO. First beam 1100 is divided into second beam 1104 and third beam 1106 by splitter 1102. Third beam 1106 reflects from fold minor 1108 to create fourth beam 1110. Fourth beam 1110 enters despeckling apparatus 1112. Despeckling apparatus 1112 generates fifth beam 1114. Second beam 1104 enters OPO 1116. OPO 1116 generates sixth beam 1118 and seventh beam 1120. First beam 1100, second beam 1104, third beam 1106, fourth beam 1110, and fifth beam 1114 may be green light. Sixth beam 1118 may be red light, and seventh beam 1120 may be blue light. Splitter 1102 may be a fixed splitter or a variable splitter. Despeckling apparatus 1112 may be a fixed despeckler or an adjustable despeckler.

FIG. 12 shows a block diagram of a three-color laser projection system with despeckling of light taken before and after an OPO. First beam 1200 is divided into second beam 1204 and third beam 1206 by splitter 1202. Third beam 1206 reflects from fold minor 1208 to create fourth beam 1210. Fourth beam 1210 enters first despeckling apparatus 1212. First despeckling apparatus 1212 generates fifth beam 1214. Second beam 1204 enters OPO 1216. OPO 1216 generates sixth beam 1218, seventh beam 1224, and eighth beam 1226. Sixth beam 1218 enters second despeckling apparatus 1220. Second despeckling apparatus 1220 generates ninth beam 1222. First beam 1200, second beam 1204, third beam 1206, fourth beam 1210, fifth beam 1214, sixth beam 1218, and ninth beam 1222 may be green light. Seventh beam 1224 may be red light, and eighth beam 1226 may be blue light. Splitter 1202 may be a fixed splitter or a variable splitter. First despeckling apparatus 1212 and second despeckling apparatus 1220 may be fixed despecklers or adjustable despecklers.

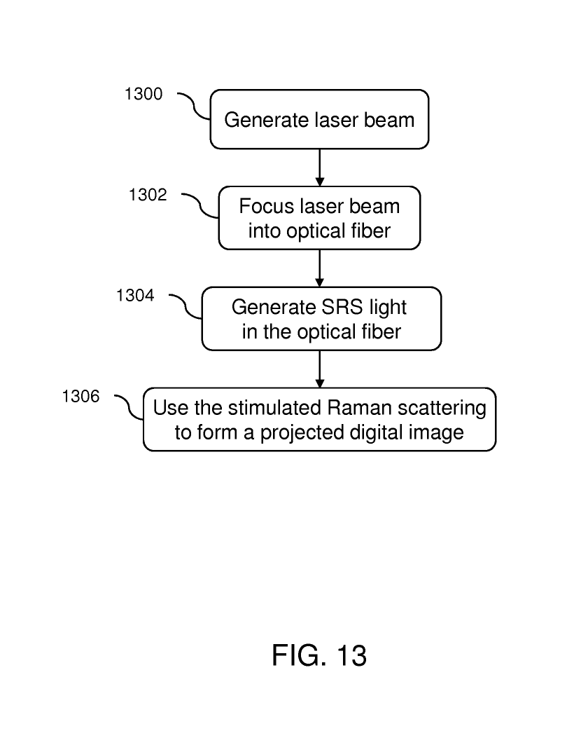

FIG. 13 shows a despeckling method that corresponds to the apparatus shown in FIG. 3. In step 1300, a laser beam is generated. In step 1302, the laser beam is focused into the core of an optical fiber. In step 1304, SRS light is generated in the optical fiber. In step 1306, the SRS light is used to form a projected digital image. Additional steps such as homogenizing, mixing, splitting, recombining, and further despeckling may also be included.

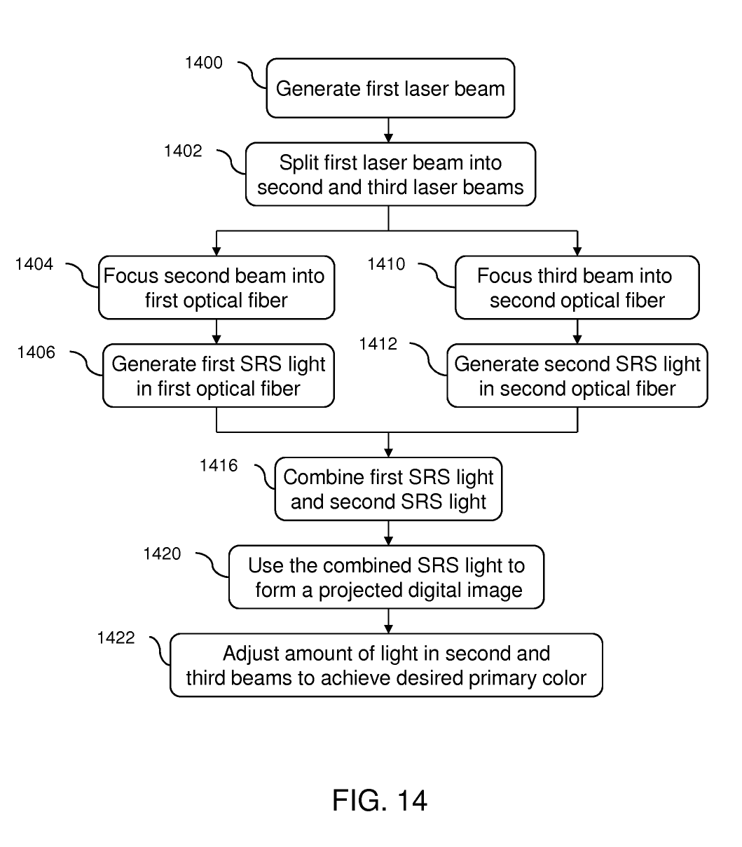

FIG. 14 shows an adjustable despeckling method that corresponds to the apparatus shown in FIG. 7. In step 1400, a first laser beam is generated. In step 1402, the first laser beam is split into second and third laser beams. In step 1404, the second laser beam is focused into the core of a first optical fiber. In step 1406, first SRS light is generated in the first optical fiber. In step 1410, the third laser beam is focused into the core of a second optical fiber. In step 1412, second SRS light is generated in the second optical fiber. In step 1416, the first SRS light and the second SRS light is combined. In step 1420, the combined SRS light is used to form a projected digital image. In step 1422, the amount of light in the second and third beams is adjusted to achieve a desired primary color. Additional steps such as homogenizing, mixing, further splitting, further recombining, and further despeckling may also be included.

Fibers used to generate SRS in a fiber-based despeckling apparatus may be single mode fibers or multimode fibers. Single mode fibers generally have a core diameter less than 10 micrometers. Multimode fibers generally have a core diameter greater than 10 micrometers. Multimode fibers may typically have core sizes in the range of 20 to 400 micrometers to generate the desired amount of SRS depending on the optical power required. For very high powers, even larger core sizes such as 1000 microns or 1500 microns may experience SRS. In general, if the power per cross-sectional area is high enough, SRS will occur. A larger cross-sectional area will require a longer length of fiber, if all other variables are held equal. The cladding of multimode fibers may have a diameter of 125 micrometers. The average optical power input into a multimode fiber to generate SRS may be in the range of 1 to 200 watts. The average optical power input into a single mode fiber to generate SRS is generally smaller than the average optical power required to generate SRS in a multimode fiber. The length of the multimode fiber may be in the range of 10 to 300 meters. For average optical power inputs in the range of 3 to 100 watts, the fiber may have a core size of 40 to 62.5 micrometers and a length of 50 to 100 meters. The core material of the optical fiber may be conventional fused silica or the core may be doped with materials such as germanium to increase the SRS effect or change the wavelengths of the SRS peaks.

In order to generate SRS, a large amount of optical power must be coupled into an optical fiber with a limited core diameter. For efficient and reliable coupling, specially built lenses, fibers, and alignment techniques may be necessary. 80 to 90% of the optical power in a free-space laser beam can usually be coupled into a multimode optical fiber. Large-diameter end caps, metalized fibers, double clad fibers, antireflection coatings on fiber faces, gradient index lenses, high temperature adhesives, and other methods are commercially available to couple many tens of watts of average optical power into fibers with core diameters in the range of 30 to 50 micrometers. Photonic or “holey” fibers may be used to make larger diameters with maintaining approximately the same Raman shifting effect. Average optical power in the hundreds of watts can be coupled into fibers with core sizes in the range of 50 to 100 micrometers. The maximum amount of SRS, and therefore the minimum amount of speckle, may be determined by the maximum power that can be reliably coupled into fibers.

Optical fibers experience scattering and absorption which cause loss of optical power. In the visible light region, the main loss is scattering. Conventional fused silica optical fiber has a loss of approximately 15 dB per kilometer in the green. Specially manufactured fiber may be green-optimized so that the loss is 10 dB per kilometer or less in the green. Loss in the blue tends to be higher than loss in the green. Loss in the red tends to be lower than loss in the green. Even with low-loss fiber, the length of fiber used for despeckling may be kept as short as possible to reduce loss. Shorter fiber means smaller core diameter to reach the same amount of SRS and therefore the same amount of despeckling. Since the difficulty of coupling high power may place a limit on the amount of power that can be coupled into a small core, coupling may also limit the minimum length of the fiber.

Lasers used with a fiber-based despeckling apparatus may be pulsed in order to reach the high peak powers required for SRS. The pulse width of the optical pulses may be in the range of 5 to 100 ns. Pulse frequencies may be in the range of 5 to 300 kHz. Peak powers may be in the range of 1 to 1000 W. The peak power per area of core (PPPA) is a metric that can help predict the amount of SRS obtained. The PPPA may be in the range of 1 to 5 kW per micrometer² in order to produce adequate SRS for despeckling. Pulsed lasers may be formed by active or passive Q-switching or other methods that can reach high peak power. The mode structure of the pulsed laser may include many peaks closely spaced in wavelength. Other nonlinear effects in addition to SRS may be used to add further despeckling. For example, self-phase modulation or four wave mixing may further broaden the spectrum to provide additional despeckling. Infrared light may be introduced to the fiber to increase the nonlinear broadening effects.

The despeckling apparatus of FIG. 3 or adjustable despeckling apparatus of FIG. 7 may be used to generate more than one primary color. For example, red primary light may be generated from green light by SRS in an optical fiber to supply some or all of the red light required for a full-color projection display. Since the SRS light has low speckle, adding SRS light to other laser light may reduce the amount of speckle in the combined light. Alternatively, if the starting laser is blue, some or all of the green primary light and red primary light may be generated from blue light by SRS in an optical fiber. Filters may be employed to remove unwanted SRS peaks. In the case of SRS from green light, the red light may be filtered out, or all peaks except the first SRS peak may be filtered out. This filtering will reduce the color change for a given amount of despeckling, but comes at the expense of efficiency if the filtered peaks are not used to help form the viewed image. Filtering out all or part of the un-shifted peak may decrease the speckle because the un-shifted peak typically has a narrower bandwidth than the shifted peaks.

The un-shifted peak after fiber despeckling is a narrow peak that contributes to the speckle of the light exciting the fiber. This unshifted peak may be filtered out from the spectrum (for example using a dichroic filter) and sent into a second despeckling fiber to make further Raman-shifted peaks and thus reduce the intensity of the un-shifted peak while retaining high efficiency. Additional despeckling fibers may cascaded if desired as long as sufficient energy is available in the un-shifted peak.

There are usually three primary colors in conventional full-color display devices, but additional primary colors may also be generated to make, for example, a four-color system or a five-color system. By dividing the SRS light with beamsplitters, the peaks which fall into each color range can be combined together to form each desired primary color. A four-color system may consist of red, green, and blue primaries with an additional yellow primary generated from green light by SRS in an optical fiber. Another four-color system may be formed by a red primary, a blue primary, a green primary in the range of 490 to 520 nm, and another green primary in the range of 520 to 550 nm, where the green primary in the range of 520 to 550 nm is generated by SRS from the green primary in the range of 490 to 520 nm. A five-color system may have a red primary, a blue primary, a green primary in the range of 490 to 520 nm, another green primary in the range of 520 to 550 nm, and a yellow primary, where the green primary in the range of 520 to 550 nm and the yellow primary are generated by SRS from the green primary in the range of 490 to 520 nm.

3D projected images may be formed by using SRS light to generate some or all of the peaks in a six-primary 3D system. Wavelengths utilized for a laser-based six-primary 3D system may be approximately 440 and 450 nm, 525 and 540 nm, and 620 and 640 nm in order to fit the colors into the blue, green, and red bands respectively and have sufficient spacing between the two sets to allow separation by filter glasses. Since the spacing of SRS peaks from a pure fused-silica core is 13.2 THz, this sets a spacing of approximately 9 nm in the blue, 13 nm in the green, and 17 nm in the red. Therefore, a second set of primary wavelengths at 449 nm, 538 nm, and 637 nm can be formed from the first set of primary wavelengths at 440 nm, 525 nm, and 620 nm by utilizing the first SRS-shifted peaks. The second set of primaries may be generated in three separate fibers, or all three may be generated in one fiber. Doping of the fiber core may be used to change the spacing or generate additional peaks.

Another method for creating a six-primary 3D system is to use the un-shifted (original) green peak plus the third SRS-shifted peak for one green channel and use the first SRS-shifted peak plus the second SRS-shifted peak for the other green channel. Fourth, fifth, and additional SRS-shifted peaks may also be combined with the un-shifted and third SRS-shifted peaks. This method has the advantage of roughly balancing the powers in the two channels. One eye will receive an image with more speckle than the other eye, but the brain can fuse a more speckled image in one eye with a less speckled image in the other eye to form one image with a speckle level that averages the two images. Another advantage is that although the wavelengths of the two green channels are different, the color of the two channels will be more closely matched than when using two single peaks from adjacent green channels. Two red channels and two blue channels may be produced with different temperatures in two OPOs which naturally despeckle the light.

Almost degenerate OPO operation can produce two wavelengths that are only slightly separated. In the case of green light generation, two different bands of green light are produced rather than red and blue bands. The two green wavelengths may be used for the two green primaries of a six-primary 3D system. If the OPO is tuned so that its two green wavelengths are separated by the SRS shift spacing, SRS-shifted peaks from both original green wavelengths will line up at the same wavelengths. This method can be used to despeckle a system utilizing one or more degenerate OPOs.

A different starting wavelength may used to increase the amount of Raman-shifted light while still maintaining a fixed green point such as DCI green. For example, a laser that generates light at 515 nm may be used as the starting wavelength and more Raman-shifted light generated to reach the DCI green point when compared to a starting wavelength of 523.5 nm. The effect of starting at 515 nm is that the resultant light at the same green point will have less speckle than light starting at 523.5 nm.

When two separate green lasers, one starting at 523.5 nm and one starting at 515 nm, are both fiber despeckled and then combined into one system, the resultant speckle will be even less than each system separately because of the increased spectral diversity. The Raman-shifted peaks from these two lasers will interleave to make a resultant waveform with approximately twice as many peaks as each green laser would have with separate operation.

A separate blue boost may also be added from a narrow band laser at any desired wavelength because speckle is very hard to see in blue even with narrow band light. The blue boost may be a diode-pumped solid-state (DPSS) or direct diode laser. The blue boost may form one of the blue peaks in a six-primary 3D display. If blue boost is used, any OPOs in the system may be tuned to produce primarily red or red only so as to increase the red efficiency.

Peaks that are SRS-shifted from green to red may be added to the red light from an OPO or may be used to supply all the red light if there is no OPO. In the case of six-primary 3D, one or more peaks shifted to red may form or help form one or more of the red channels.

Instead of or in addition to fused silica, materials may be used that add, remove, or alter SRS peaks as desired. These additional materials may be dopants or may be bulk materials added at the beginning or the end of the optical fiber.

The cladding of the optical fiber keeps the peak power density high in the fiber core by containing the light in a small volume. Instead of or in addition to cladding, various methods may be used to contain the light such as minors, focusing optics, or multi-pass optics. Instead of an optical fiber, larger diameter optics may used such as a bulk glass or crystal rod or rectangular parallelepiped. Multiple passes through a crystal or rod may be required to build sufficient intensity to generate SRS. Liquid waveguides may be used and may add flexibility when the diameter is increased.

Polarization-preserving fiber or other polarization-preserving optical elements may be used to contain the light that generates SRS. A rectangular-cross-section integrating rod or rectangular-cross-section fiber are examples of polarization-preserving elements. Polarization-preserving fibers may include core asymmetry or multiple stress-raising rods that guide polarized light in such a way as to maintain polarization.

In a typical projection system, there is a trade-off between brightness, contrast ratio, uniformity, and speckle. High illumination f# tends to produce high brightness and high contrast ratio, but also tends to give low uniformity and more speckle. Low illumination f# tends to produce high uniformity and low speckle, but also tends to give low brightness and low contrast ratio. By using spectral broadening to reduce speckle, the f# of the illumination system can be raised to help increase brightness and contrast ratio while keeping low speckle. Additional changes may be required to make high uniformity at high f#, such as a longer integrating rod, or other homogenization techniques which are known and used in projection illumination assemblies.

If two OPOs are used together, the OPOs may be adjusted to slightly different temperatures so that the resultant wavelengths are different. Although the net wavelength can still achieve the target color, the bandwidth is increased to be the sum of the bandwidths of the individual OPOs. Increased despeckling will result from the increased bandwidth. The bands produced by each OPO may be adjacent, or may be separated by a gap. In the case of red and blue generation, both red and blue will be widened when using this technique. For systems with three primary colors, there may be two closely-spaced red peaks, four or more green peaks, and two closely-spaced blue peaks. For systems with six primary colors, there may be three or more red peaks with two or more of the red peaks being closely spaced, four or more green peaks, and three or more blue peaks with two or more of the blue peaks being closely spaced. Instead of OPOs, other laser technologies may be used that can generate the required multiple wavelengths.

Screen vibration or shaking is a well-known method of reducing speckle. The amount of screen vibration necessary to reduce speckle to a tolerable level depends on a variety of factors including the spectral diversity of the laser light impinging on the screen. By using Raman to broaden the spectrum of light, the required screen vibration can be dramatically reduced even for silver screens or high-gain white screens that are commonly used for polarized 3D or very large theaters. These specialized screens typically show more speckle than low-gain screens. When using Raman despeckling, screen vibration may be reduced to a level on the order of a millimeter or even a fraction of a millimeter, so that screen vibration becomes practical and easily applied even in the case of large cinema screens.

A combination of green laser diodes and Raman-despeckled DPSS lasers may be used to form a multiple laser projection system with excellent performance. The performance factors may include despeckling, color space, and efficiency. The desired color space may be Rec. 709 or DCI. Additional lasers such as potassium gadolinium tungstate (KGW) lasers may be added to further improve performance. In the case of six primary 3D systems, a further performance factor is color separation between the eyes to minimize ghosting effects. A combination of green laser diodes, Raman-despeckled DPSS lasers, and KGW lasers is able to achieve despeckling, DCI color space, efficiency, and separation requirements for a Digital Cinema six primary projection system.

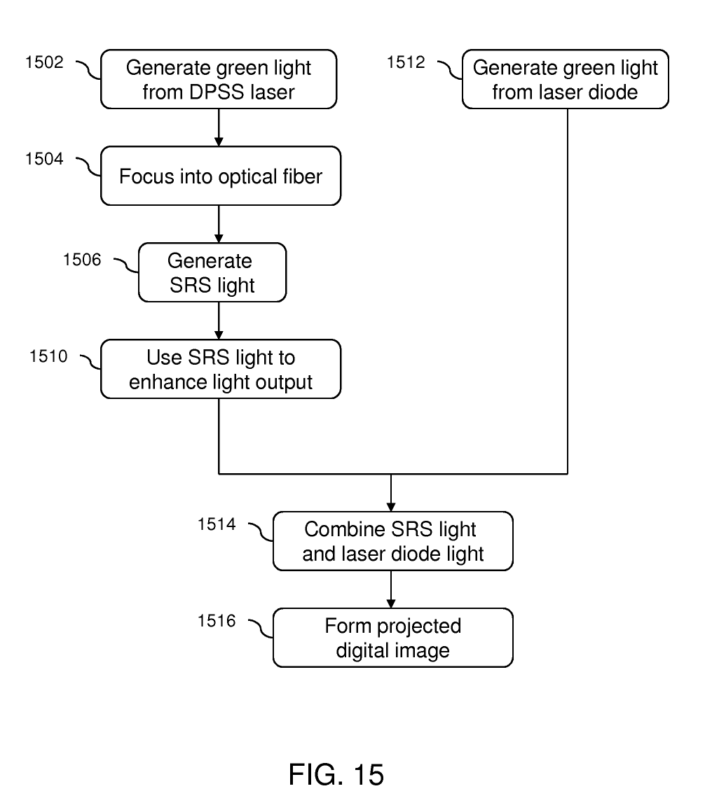

FIG. 15 shows a flowchart of a method of combining green light from a DPSS laser and green light from a laser diode. In step 1502, green light is generated from a DPSS laser. In step 1504, the green light from the DPSS laser is focused into an optical fiber. In step 1506, SRS light is generated in the optical fiber. In step 1510, the SRS light is used to enhance the light output from the optical fiber. In step 1512, green light is generated from a laser diode. In step 1514, the light from the optical fiber and the light from the laser diode are combined. In step 1516, the combined light is used to form a projected digital image. Enhancing the light output from the optical fiber may include reducing speckle, changing the color of the light, or changing any other optical property of the light to improve the quality of the light for the purpose of forming images. Multiple laser diodes may be aggregated and their light may be fiber delivered prior to combining with the light from the optical fiber.

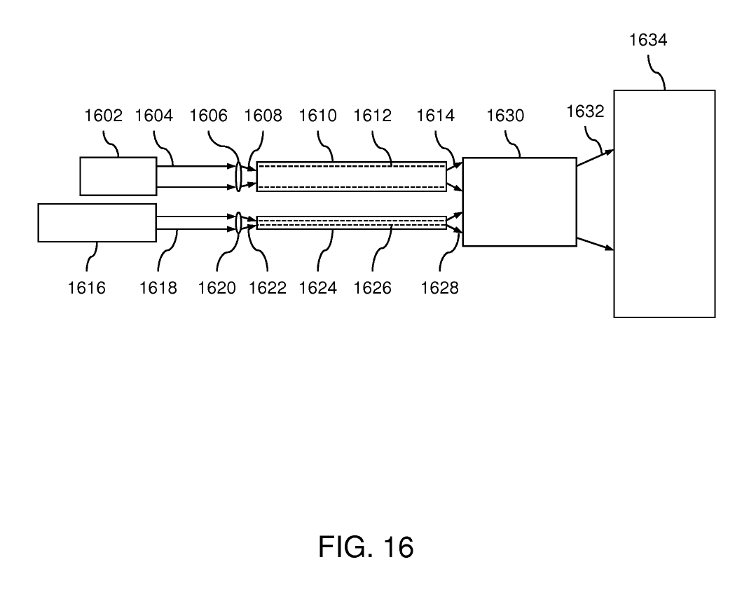

FIG. 16 shows a top view of a laser projector system that includes a green DPSS laser and a green laser diode. Green laser diode 1602 generates first light beam 1604. First light beam 1604 illuminates first light coupling system 1606. First light coupling system 1606 generates second light beam 1608. Second light beam 1608 illuminates first optical fiber 1610 which has first core 1612. First optical fiber 1610 generates third light beam 1614. Third light beam 1614 illuminates homogenizing device 1630. Green DPSS laser 1616 generates fourth light beam 1618. Fourth light beam 1618 illuminates second light coupling system 1620. Second light coupling system 1620 generates fifth light beam 1622. Fifth light beam 1622 illuminates second optical fiber 1624 which has second core 1626. Second optical fiber 1624 generates sixth light beam 1628. Sixth light beam 1628 illuminates homogenizing device 1630. Homogenizing device 1632 combines third light beam 1614 with sixth light beam 1628 to generate seventh light beam 1632. Seventh light beam 1632 illuminates digital projector 1634. There may be additional elements not shown in FIG. 16 which are between the parts illuminating and the parts being illuminated. For example, there may be additional lenses before homogenizing device 1632 to adjust the divergence of the light beams so that the homogenizing device operates with the proper amount of homogenization. Green laser diode 1602 does not generate SRS in first optical fiber 1610. Green DPSS laser 1616 is a pulsed laser that has high enough peak power to produce SRS in second optical fiber 1624. First light coupling system 1606 and second light coupling system 1620 may each be one lens, a sequence of lenses, or other optical components designed to focus light into first core 1612 and second core 1626. Second optical fiber 1624 may be an optical fiber with a core size and length selected to produce the desired amount of SRS. Homogenizing device 1630 may be a mixing rod, fly's eye lens, diffuser, or other optical component that improves the spatial uniformity of the light beam. Digital projector 1634 may be a projector based on digital micromirror (DMD), liquid crystal device (LCD), liquid crystal on silicon (LCOS), or other digital light valves. Additional elements may be included to further guide or despeckle the light such as additional lenses, diffusers, vibrators, or optical fibers. Instead of homogenizing element 1630, other ways may be employed to combine the light from green laser diode 1602 and green DPSS laser 1616. Multiple green laser diodes may be aggregated to increase the power and bandwidth.

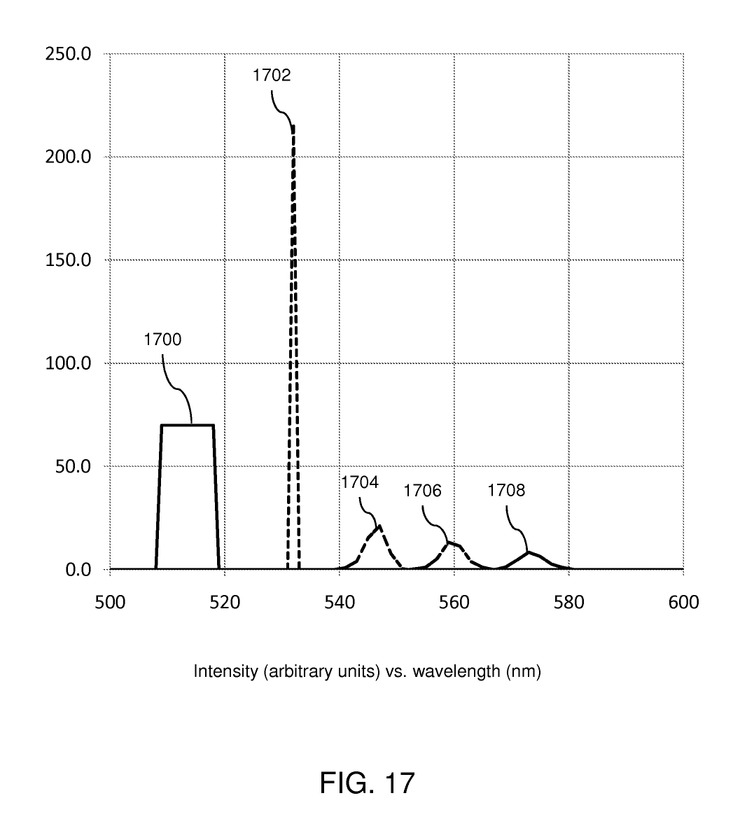

FIG. 17 shows a spectral graph of a laser projector system that includes a green DPSS laser and a green laser diode. The x-axis represents wavelength in nanometers (nm) and the y-axis represents intensity in arbitrary units. First peak 1700 covers the range from 509 nm to 518 nm. This wavelength range can be generated by an aggregation of green laser diodes of different wavelengths. Each green laser diode may have a bandwidth of approximately 2 nm, so at least 5 laser diodes may be required to cover the range in this example. Second peak 1702 at 532 nm is residual (unshifted) green light from an optical fiber. This wavelength may be produced by a neodymium-doped yttrium orthovanadate (Nd:YVO4) DPSS laser or other frequency-doubled pulsed green laser. Third peak 1704 at 545.6 nm, fourth peak 1706 at 559.8 nm, and fifth peak 1708 at 574.8 nm, are generated by Raman shift from 532 nm in a fused-silica optical fiber. First peak 1700 (shown by a solid line in FIG. 17) may form the first image of a stereoscopic image. Second peak 1702, third peak 1704, fourth peak 1706, and fifth peak 1708 (shown by a dashed line in FIG. 17) may form the second image of the stereoscopic image. The spectral separation between first and second images for a six-primary 3D system may be primarily determined by the separation between first peak 1700 and second peak 1702 which is 14 nm. This separation is sufficient for high quality imaging with minimal ghosting or cross-talk between the eyes. The bandwidth of each image is approximately 9 nm which is sufficient for minimal speckle on a white or low-gain screen for most applications including digital cinema. Optical efficiency may be high because none of the light from the green laser diodes, DPSS laser, or KGW laser is filtered out in order to achieve the desired color space.

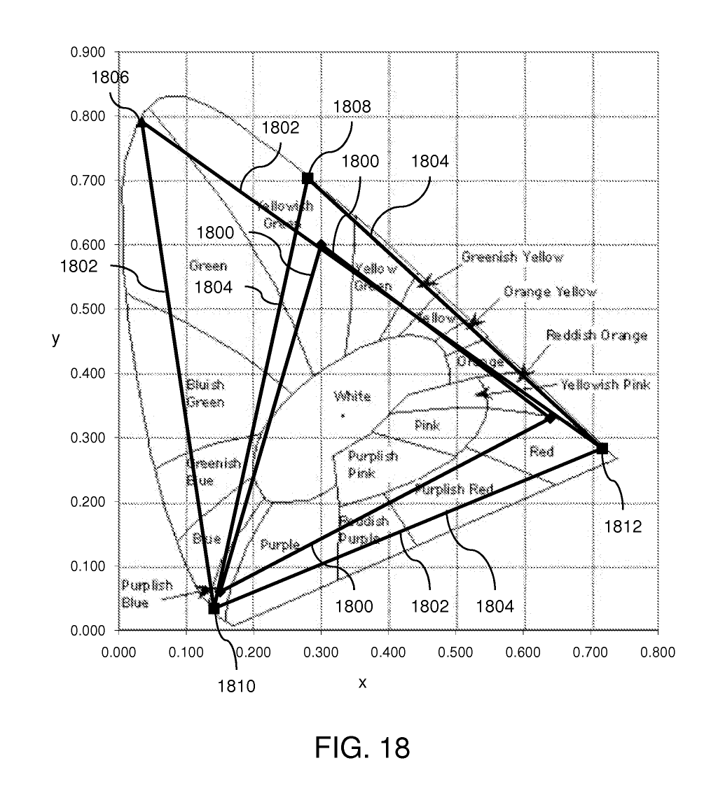

FIG. 18 shows a color plot of a laser projector system that includes a green DPSS laser and a green laser diode. The x and y axes of FIG. 18 represent the x and y coordinates of the CIE 1931 color space. First triangle 1800 shows the Rec. 709 color gamut. Second triangle 1802 shows the color gamut of the native laser primaries using the green light from laser diodes as shown in first peak 1700 of FIG. 17. Third triangle 1804 shows the color gamut of the native laser primaries using green light from a fiber-despeckled 532 nm DPSS laser as shown in second peak 1702, third peak 1704, fourth peak 1706, and fifth peak 1708 of FIG. 17. First point 1806 shows the color of 509 nm to 518 nm green laser diodes. Second point 1808 shows the color of a fiber-despeckled 532 nm DPSS laser. Third point 1810 shows the color of blue laser diodes at 462 nm. Fourth point 1812 shows the color of red laser diodes as 638 nm. The combination of first point 1806, third point 1810, and fourth point 1812 forms second triangle 1802. The combination of second point 1808, third point 1810, and fourth point 1812 forms third triangle 1804. The native colors from second triangle 1802 may be mixed in a digital projector to form the Rec. 709 primary colors of first triangle 1800 for one eye of a six-primary stereoscopic image. The native colors from third triangle 1804 may be mixed in the same or a second digital projector to form the Rec. 709 primary colors of first triangle 1800 for the second eye of a six-primary stereoscopic image.

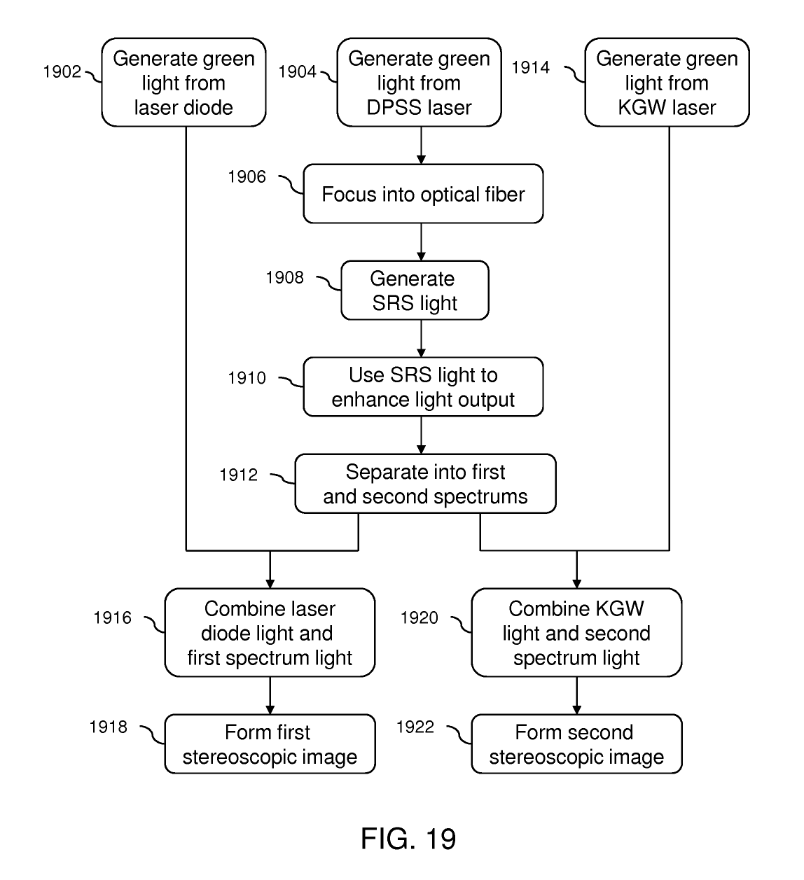

FIG. 19 shows a flowchart of a method of combining green light from a DPSS laser, green light from a laser diode, and green light from a KGW laser. In step 1902, green light is generated from a laser diode. In step 1904, green light is generated from a DPSS laser. In step 1906, the green light from the DPSS laser is focused into an optical fiber. In step 1908, SRS light is generated in the optical fiber. In step 1910, the SRS light is used to enhance the light output from the optical fiber. In step 1912, the light from the optical fiber is separated into two spectrums of light. In step 1914, green light is generated from a KGW laser. In step 1916, the light from the laser diode and the light from one of the two spectrums are combined. In step 1918, the combined light is used to from the first image of a stereoscopic image. In step 1920, the light from the KGW laser and the light from the other of the two spectrums are combined. In step 1922, the combined light is used to from the second image of a stereoscopic image. Enhancing the light output from the optical fiber may include reducing speckle, changing the color of the light, or changing any other optical property of the light to improve the quality of the light for the purpose of forming images. Multiple laser diodes may be aggregated and their light may be fiber delivered prior to combining with the light from the optical fiber. The two spectrums may be separated by splitting the SRS peaks and residual (unshifted) green peak. One split or multiple splits may occur between any of the SRS peaks and/or the residual green peak. The KGW laser may be any DPSS laser that includes a nonlinear KGW crystal that generates a Raman-shifted peak or multiple Raman-shifted peaks.

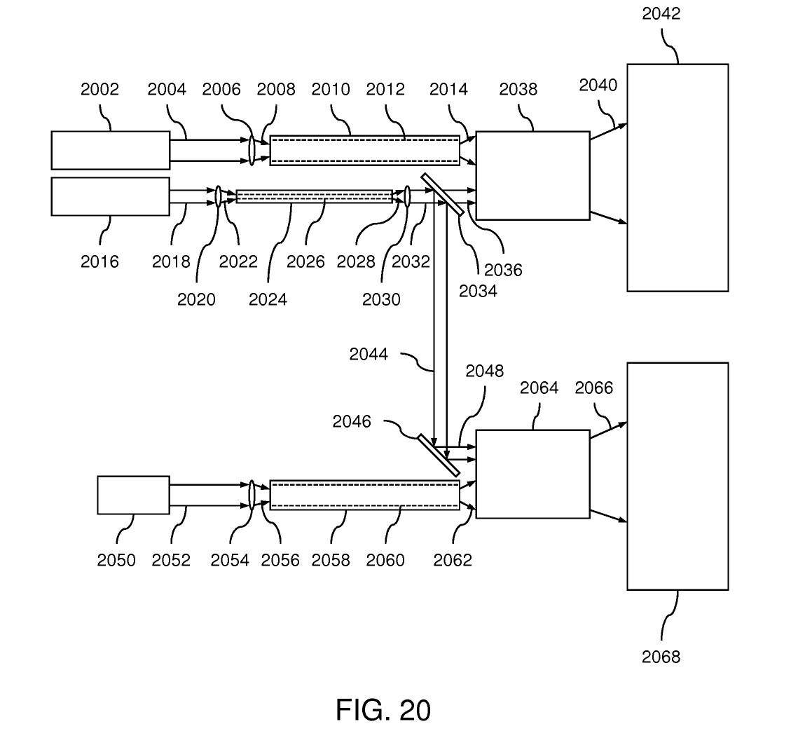

FIG. 20 shows a top view of a laser projector system that includes a green DPSS laser, a green laser diode, and a KGW laser. KGW laser 2002 generates first light beam 2004. First light beam 2004 illuminates first light coupling system 2006. First light coupling system 2006 generates second light beam 2008. Second light beam 2008 illuminates first optical fiber 2010 which has first core 2012. First optical fiber 2010 generates third light beam 2014. Third light beam 2014 illuminates first homogenizing device 2038. Green DPSS laser 2016 generates fourth light beam 2018. Fourth light beam 2018 illuminates second light coupling system 2020. Second light coupling system 2020 generates fifth light beam 2022. Fifth light beam 2022 illuminates second optical fiber 2024 which has second core 2026. Second optical fiber 2024 generates sixth light beam 2028. Sixth light beam 2028 illuminates collimating light system 2030. Collimating light system 2030 generates seventh light beam 2032. Seventh light beam 2032 illuminates beamsplitter 2034. Beamsplitter 2034 separates seventh light beam 2032 into eighth light beam 2036 and ninth light beam 2044. Eighth light beam 2036 illuminates first homogenizing device 2038. First homogenizing device 2038 combines third light beam 2014 with eighth light beam 2036 to generate tenth light beam 2040. Tenth light beam 2040 illuminates first digital projector 2042.

Ninth light beam 2044 reflects from mirror 2046 to form eleventh light beam 2048. Eleventh light beam 2048 illuminates second homogenizing device 2064. Green laser diode 2050 generates twelfth light beam 2052. Twelfth light beam 2052 illuminates third light coupling system 2054. Third light coupling system 2054 generates thirteenth light beam 2056. Thirteenth light beam 2056 illuminates third optical fiber 2058 which has third core 2060. Third optical fiber 2058 generates fourteenth light beam 2062. Fourteenth light beam 2062 illuminates second homogenizing device 2064. Second homogenizing device 2064 combines eleventh light beam 2048 with fourteenth light beam 2062 to generate fifteenth light beam 2066. Fifteenth light beam 2066 illuminates second digital projector 2068. There may be additional elements not shown in FIG. 20 which are between the parts illuminating and the parts being illuminated. For example, there may be additional lenses before first homogenizing device 2038 and second homogenizing device 2064 to adjust the divergence of the light beams so that the homogenizing devices operate with the proper amount of homogenization. KGW laser 2002 does not generate SRS in first optical fiber 2010. Green DPSS laser 2016 is a pulsed laser that has high enough peak power to produce SRS in second optical fiber 2024. Green laser diode 2050 does not generate SRS in third optical fiber 2058. First light coupling system 2006, second light coupling system 2020, and third light coupling system 2054 may each be one lens, a sequence of lenses, or other optical components designed to focus light into first core 2012, second core 2026, and third core 2060. Second optical fiber 2024 may be an optical fiber with a core size and length selected to produce the desired amount of SRS. First homogenizing device 2038 and second homogenizing device 2064 may each be a mixing rod, fly's eye lens, diffuser, or other optical component that improves the spatial uniformity of the light beam. First digital projector 2042 and second digital projector 2068 may each be a projector based on digital micromirror (DMD), liquid crystal device (LCD), liquid crystal on silicon (LCOS), or other digital light valves. Additional elements may be included to further guide or despeckle the light such as additional lenses, diffusers, vibrators, or optical fibers. Instead of first homogenizing element 2038 and second homogenizing element 2064, other ways may be employed to combine the light from KGW laser 2002, green DPSS laser 2016, and green laser diode 2050. Multiple green laser diodes may be aggregated to increase the power and bandwidth.

Collimating light system 2030 may be one lens, a sequence of lenses, or other optical components designed to collimate or otherwise guide seventh light beam 2032. Beamsplitter 2034 may be an multilayer interference filter or other optical fiber that separates seventh light beam 2032 into two optical spectrums corresponding to eighth light beam 2036 and ninth light beam 2044. One optical spectrum may be reflected and the other optical spectrum may be transmitted by beamsplitter 2034. Mirror 2046 may be a broadband optical reflector or other type of minor that reflects ninth light beam 2044. First digital projector 2042 may form one image and second digital projector 2068 may form the other image of a six-primary stereoscopic image. There may additional filters to modify the two spectrums of eighth light beam 2036 and ninth light beam 2044.

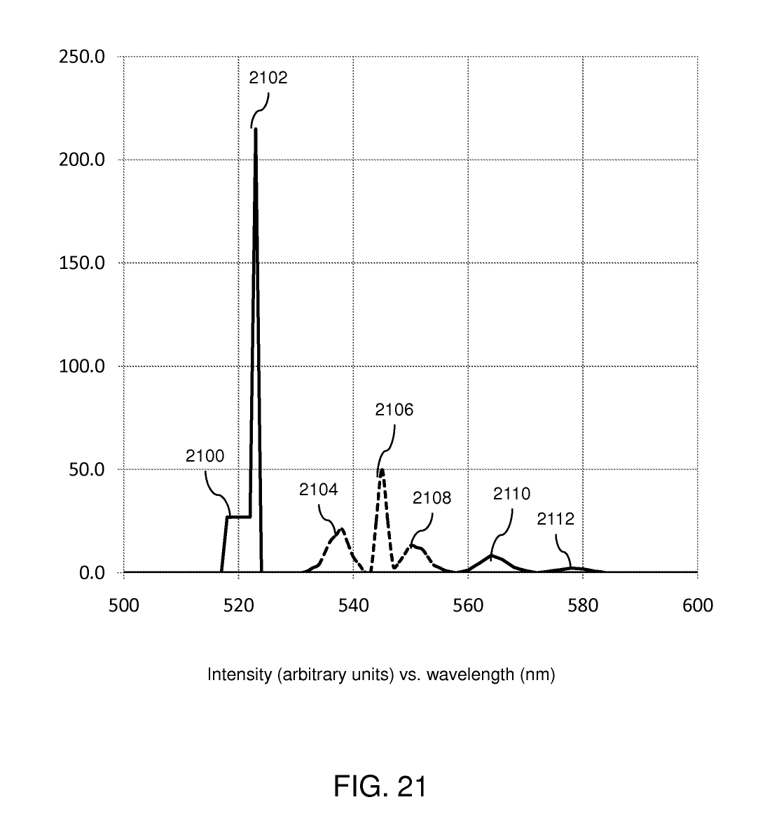

FIG. 21 shows a spectral graph of a laser projector system that includes a green DPSS laser, a green laser diode, and a KGW laser. The x-axis represents wavelength in nanometers (nm) and the y-axis represents intensity in arbitrary units. First peak 2100 covers the range from 518 nm to 523.5 nm. This wavelength range can be generated by an aggregation of green laser diodes of different wavelengths. Each green laser diode may have a bandwidth of approximately 2 nm, so at least 3 laser diodes may be required to cover the range in this example. Second peak 2102 at 532.5 nm is residual (unshifted) green light from an optical fiber. This wavelength may be produced by an Nd:YLF DPSS laser or other frequency-doubled pulsed green laser. Third peak 2104 at 536.6 nm, fifth peak 2108 at 550.4 nm, sixth peak 2110 at 564.9 nm, and seventh peak 2112 at 580.2 nm, are generated by Raman shift from 532.5 nm in a fused-silica optical fiber. Fourth peak 2106 at 545.4 nm is generated by a KGW laser. First peak 2100, second peak 2102, sixth peak 2110, and seventh peak 2112 (shown by a solid line in FIG. 21) may form the first image of a stereoscopic image. Third peak 2104, fourth peak 2106, and fifth peak 2108 (shown by a dashed line in FIG. 21) may form the second image of the stereoscopic image. The spectral separation between first and second images for a six-primary 3D system may be primarily determined by the separation between second peak 2102 and third peak 2104 which is 13 nm. This separation is sufficient for high quality imaging with minimal ghosting or cross-talk between the eyes. The bandwidth of each image is approximately 9 nm which is sufficient for minimal speckle on a white or low-gain screen for most applications including digital cinema. Optical efficiency may be high because none of the light from the green laser diodes, DPSS laser, or KGW laser is filtered out in order to achieve the desired color space.

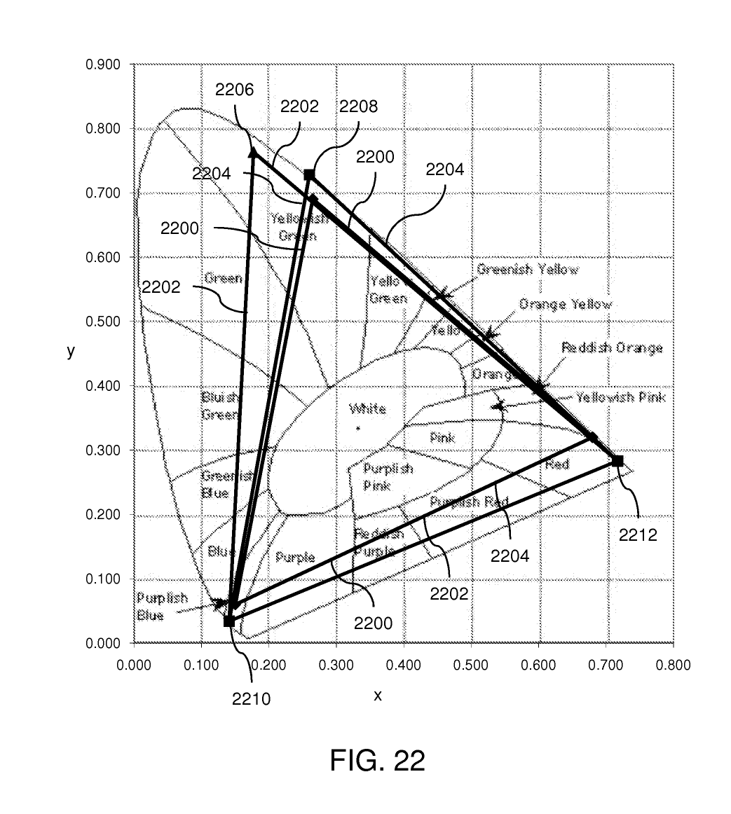

FIG. 22 shows a color plot of a laser projector system that includes a green DPSS laser, a green laser diode, and a KGW laser. The x and y axes of FIG. 22 represent the x and y coordinates of the CIE 1931 color space. First triangle 2200 shows the DCI color gamut. Second triangle 2202 shows the color gamut of the native laser primaries using the green light from laser diodes, residual green light from the optical fiber, and some of the SRS-shifted peaks as shown in first peak 2100, second peak 2102, sixth peak 2110, and seventh peak 2112 of FIG. 21. Third triangle 2204 shows the color gamut of the native laser primaries using green light from a KGW laser and the other SRS-shifted peaks as shown in third peak 2104, fourth peak 2106, and fifth peak 2108 of FIG. 21. First point 2206 shows the color of 518 nm to 523.5 nm green laser diodes combined with the residual green light from the optical fiber and some of the SRS-shifted peaks as shown in first peak 2100, second peak 2102, sixth peak 2110, and seventh peak 2112 of FIG. 21. Second point 2208 shows the color of a KGW laser and the other SRS-shifted peaks as shown in third peak 2104, fourth peak 2206, and fifth peak 2108 of FIG. 21. Third point 2210 shows the color of blue laser diodes at 462 nm. Fourth point 2212 shows the color of red laser diodes at 638 nm. The combination of first point 2206, third point 2210, and fourth point 2212 forms second triangle 2202. The combination of second point 2208, third point 2210, and fourth point 2212 forms third triangle 2204. The native colors from second triangle 2202 may be mixed in a digital projector to form the DCI primary colors of first triangle 2200 for one eye of a six-primary stereoscopic image. The native colors from third triangle 2204 may be mixed in the same or a second digital projector to form the DCI primary colors of first triangle 2200 for the second eye of a six-primary stereoscopic image.

A KGW laser may be constructed utilizing a solid-state KGW crystal to provide Raman shifting in order to create a Raman laser. The Raman laser cavity may include a high reflector mirror that reflects the first Stokes line and transmits the pump wavelength, a KGW crystal, and an output coupling minor that partially reflects at the first Stokes line and transmits the pump wavelength. The KGW laser can be used to shift the output wavelength longer than the pump wavelength. For example, the pump wavelength may be a green laser beam at 523.5 or 526.5 nm and the resulting KGW output will be at 545.5 nm or 548.7 nm respectively. Design of the KGW laser may include determining the optimum KGW crystal length, KGW crystal beam orientation, and the pump beam size in the KGW crystal. The high reflector mirror and output coupler may be selected with minor curvatures and reflective coatings to create a Raman laser with the KGW crystal in the lasing cavity. The KGW laser may include a dichroic beamsplitter so that the output of the KGW laser is a single 545.5 nm wavelength without emitting significant pump light at 523.5 nm.

In addition to the example laser systems described above, other configurations may be employed that utilize alternate combinations of lasers and spectral splits between the stereoscopic images. Depending on the application, various combinations of green laser diodes, green DPSS lasers without a Raman-shifting crystal, and green DPSS lasers with a Raman-shifting crystal, may be used to form images with various spectrums for left eye and right eye images.

Other implementations are also within the scope of the following claims.

What is claimed is:

1. An image projection method comprising:
generating a first green laser light from a green laser diode;
generating a second green laser light from a first diode-pumped solid-state laser;
focusing the second green laser light into an optical fiber;
generating a stimulated Raman scattering light;
using the stimulated Raman scattering light to enhance an aspect of a light output of the optical fiber; and
combining the first green laser light and the stimulated Raman scattering light, to form a projected digital image.

2. The method of claim 1 wherein the aspect of the light output of the optical fiber is a color of the output of the optical fiber.

3. The method of claim 1 wherein the aspect of the light output of the optical fiber is a speckle characteristic of the output of the optical fiber.

4. The method of claim 1 wherein the second green laser light has a wavelength of 532.5 nm.

5. The method of claim 1 wherein the second green laser light has a wavelength of 523.5 nm.

6. The method of claim 5 further comprising:
generating a third green laser light from a second diode-pumped solid-state laser that comprises a potassium gadolinium tungstate Raman crystal; and
combining the third green laser light, the first green laser light, and the stimulated Raman scattering light, to form a projected digital image.

7. The method of claim 6 wherein the second diode-pumped solid-state laser has a single light output at a wavelength of 545.4 nm.

8. The method of claim 7 further comprising:
separating the light output of the optical fiber into a first spectrum light and a second spectrum light;
wherein the projected digital image is a stereoscopic image; a first image of the stereoscopic image is formed from the first green laser light and the first spectrum light; and a second image of the stereoscopic image is formed from the third green laser light and the second spectrum light.

9. An optical apparatus comprising:
a green laser diode that generates a first green laser light;
a first diode-pumped solid state laser that generates a second green laser light; and
an optical fiber;
wherein the second green laser light is focused into the optical fiber; the optical fiber generates a stimulated Raman scattering light that enhances an aspect of a light output of the optical fiber; and the first green laser light and the stimulated Raman scattering light are combined to form a projected digital image.

10. The apparatus of claim 9 wherein the aspect of the light output of the optical fiber is a color of the output of the optical fiber.

11. The apparatus of claim 9 wherein the aspect of the light output of the optical fiber is a speckle characteristic of the output of the optical fiber.

12. The apparatus of claim 9 wherein the second green laser light has a wavelength of 532 nm.

13. The apparatus of claim 9 wherein the second green laser light has a wavelength of 523.5 nm.

14. The apparatus of claim 13 further comprising:
a second diode-pumped solid-state laser that comprises a potassium gadolinium tungstate Raman crystal; and
the second diode-pumped solid-state laser generates a third green laser light; and
the third green laser light, the first green laser light, and the stimulated Raman scattering light, are combined to form the projected digital image.

15. The apparatus of claim 14 wherein the second diode-pumped solid-state laser has a single light output at a wavelength of 545 nm.

16. The apparatus of claim 13 further comprising:
a beamsplitter that separates the light output of the optical fiber into a first spectrum light and a second spectrum light.

17. The apparatus of claim 16 wherein the projected digital image is a stereoscopic image; and a first image of the stereoscopic image is formed from the first green laser light and the first spectrum light; and a second image of the stereoscopic image is formed from the third green laser light and the second spectrum light.
